(19) United States
(12) Patent Application Publication
(10) Pub. No.: US 2005/0129929 A1
(43) Pub. Date: Jun. 16, 2005

(54) Antimicrobial metal-ion sequestering web for application to a surface

(75) Inventors: David L. Patton, Webster, NY (US); Joseph F. Bringley, Rochester, NY (US); Richard W. Wien, Pittsford, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/868,730

(22) Filed: Jun. 15, 2004

Related U.S. Application Data
(63) Continuation-in-part of application No. 10/737,346, filed on Dec. 16, 2003.

(51) Int. Cl. B32B 5/16

(52) U.S. Cl. 428/328; 428/334; 428/335

(57) ABSTRACT

A flexible support layer having a first side and a second side, a flexible antimicrobial and metal-ion sequestering layer adjacent the first side of the support layer, a flexible polymeric layer adjacent said flexible support layer or said flexible antimicrobial layer having an immobilized metal-ion sequestering agent and a flexible adhesive layer adjacent the second side of the support layer.

### CROSS REFERNCE TO RELATED APPLICATIONS

This is a Continuation-in-Part of Ser. No. 10/737, 346 filed Dec. 16, 20003 entitled Antimicrobial Web For Application to a Surface by David Patton et al.

Reference is made to commonly assigned U.S. patent application Ser. No. ______ filed Jun. 15, 2004 entitled “An Iron Sequestering Antimicrobial Composition” by Joseph F. Bringley, et al. (Docket 88081), and commonly assigned U.S. patent application Ser. No. ______ filed Jun. 15, 2004 entitled “Composition Comprising Metal-Ion Sequestrant” by Joseph F. Bringley (Docket 88079) incorporated herein by reference.

### FIELD OF THE INVENTION

The present invention relates to a medium containing a combination of iron sequestering agents and antimicrobial materials that is able to limit the growth of harmful microorganisms and prevent microbial contamination. The medium also provides a means of indicating the effectiveness of antimicrobial activity. The medium further has an adhesive layer so it can be adhered to a surface such as a counter top and/or changes visual appearance as the material reaches a predetermined state.

### BACKGROUND OF THE INVENTION

In recent years people have become very concerned about exposure to the hazards of bacterial contamination. For example, exposure to certain strains of Eschericia coli through the ingestion of under-cooked beef can have fatal consequences. Exposure to Salmonella enteritidis through contact with unwashed poultry can cause severe nausea and exposure to Staphylococcus aureus, Klebsiella pneumoniae, yeast (Candida albicans) can cause skin infections. In some instances bacterial contamination alters the taste of the food or drink or makes the food unappetizing. With the increased concern by consumers, manufacturers have started to produce products having antimicrobial properties.

In the area of food preparation, counter tops, table and cabinets are made using high-pressure laminates as discussed in U.S. Pat. No. 6,248,342. When used in food preparation areas, high-pressure laminates often come in contact with food and are a breeding ground for bacteria, fungi, and other microorganisms. Therefore, attempts have been made to develop high-pressure laminates having antimicrobial properties. For example, the organic compound triclosan has been incorporated in countertops to provide a surface having antimicrobial properties.

Nobel metal ions such as silver and gold ions are known for their anti-microbial activities and have been used in medical care for many years to prevent and treat infection.

Patents U.S. Pat. No. 5,556,699 and U.S. Pat. No. 6,436,422 disclose antibiotic materials containing zeolites for use as materials for packaging foods, medical equipment and accessories. U.S. Pat. No. 6,555,599 discloses an antimicrobial vulcanized EPDM rubber-containing article having sufficient antimicrobial activity and structural integrity to withstand repeated use without losing either antimicrobial power or modulus strength.

It has also been recognized that small concentrations of metal ions play an important role in biological processes. For example, Mn, Fe, Ca, Zn, Cu and Al are essential bio-metals, and are required for most, if not all, living systems. Metal ions play a crucial role in oxygen transport in living systems, and regulate the function of genes and replication in many cellular systems. It has been recognized that iron is an essential biological element, and that all living organisms require iron for survival and replication. Although the occurrence and concentration of iron is relatively high on the earth's surface, the availability of “free” iron is severely limited by the extreme insolubility of iron in aqueous environments. As a result, many organisms have developed complex methods of procuring “free” iron for survival and replication; and depend directly upon these mechanisms for their survival. United states patent application Ser. Nos. 10/822,940 filed Apr. 13, 2004 entitled DERIVATIZED NANOPARTICLE COMPRISING METAL-ION SEQUESTRANT by Joseph F. Bringley, 10/823,443 filed Apr. 13, 2004 entitled USE OF DERIVATIZED NANOPARTICLES TO MINIMIZE GROWTH OF MICRO-ORGANISMS IN HOT FILLED DRINKS by Richard W. Wien, et al., Ser. No. 10/823,446 filed Apr. 13, 2004 entitled CONTAINER FOR INHIBITING MICROBIAL GROWTH IN LIQUID NUTRIENTS by David L. Patton et al., Ser. No. 10/822,929 filed Apr. 13, 2004 entitled COMPOSITION OF MATTER COMPRISING POLYMER AND DERIVATIZED NANOPARTICLES by Joseph F. Bringley et al., Ser. No. 10/822,939 filed Apr. 13, 2004 entitled COMPOSITION COMPRISING INTERCALATED METAL-ION SEQUESTRANTS by Joseph F. Bringley, et al., Ser. No. 10/823,453 filed Apr. 13, 2004 entitled ARTICLE FOR INHIBITING MICROBIAL GROWTH by Joseph F. Bringley et al., Ser. No. 10/822,945 filed Apr. 13, 2004 entitled ARTICLE FOR INHIBITING MICROBIAL GROWTH IN PHYSIOLOGICAL FLUIDS by Joseph F. Bringley et al. describe materials and methods for sequestering iron, and other bio-essential elements, and preventing microbial growth. The materials and methods limit the availability of bio-essential elements to microbial organisms and hence retard or prevent their growth.

There is a problem in that antimicrobial films may quickly be depleted of antimicrobial active materials and become inert or non-functional. Depletion results from rapid diffusion of the active materials into the biological environment with which they are in contact. Once the film and the contacting environment is depleted of antimicrobial materials, microorganisms may resume growth. There is a further problem in that it is heretofore impossible to distinguish a depleted or inactive film from a working film using common human senses such as sight, smell or touch. Thus, users are unable to determine if a surface is antimicrobially safe for continued operation. When surface such as countertops lose this effectiveness in preventing bacterial growth, they are expensive and difficult to replace.

### Problem to be Solved by the Invention

There remains a need for antimicrobial films which are more effective in their ability to inhibit or prevent microbial contamination. There remains a need to provide a perceivable indication to the user that the antimicrobial material is depleted or has worn away, thus prompting the user that the film needs to be replaced. The film also can be easily applied to a surface such as a countertop or other work surface and easily removed when the antimicrobial properties have been depleted.

The present invention is also directed to the problem of the growth of micro-organism in liquids that occur and remain on food preparation surfaces that adversely affects food quality.

### SUMMARY OF THE INVENTION

In accordance with one aspect of the present invention there is provided a flexible multi-layer medium comprising:
a flexible support layer having a first side and a second side;
a flexible antimicrobial layer adjacent said first side of said support layer;
a flexible a polymeric layer adjacent said flexible support layer or said flexible antimicrobial layer having an immobilized metal-ion sequestering agent; and
a flexible adhesive layer adjacent said second side of said support layer.

In accordance with another aspect of the present invention there is provided a multi-layer medium comprising:
a support layer having a first side and a second side;
an antimicrobial layer adjacent said first side of said support layer, said antimicrobial layer having an indicating means for providing a visual indication of the effectiveness of the antimicrobial layer;
a flexible polymeric layer adjacent said flexible support layer or said flexible antimicrobial layer having an immobilized metal-ion sequestering agent; and
an adhesive layer adjacent said second side of said support layer.

In accordance with still another aspect of the present invention there is provided a multi-layer medium comprising:
a support layer having a first side and a second side;
an antimicrobial layer adjacent said first side of said support layer having controlled release of the active antimicrobial ingredient in said antimicrobial layer;
a flexible polymeric layer adjacent said flexible support layer or said flexible antimicrobial layer having an immobilized metal-ion sequestering agent; and
an adhesive layer adjacent said second side of said support layer.

In accordance with still another aspect of the present invention there is provided a plurality of multi-layer sheets layered together to form a stack of flexible multi-layer medium comprising: a flexible support layer having a first side and a second side; a
flexible antimicrobial layer adjacent said first side of said support layer;
a flexible polymeric layer adjacent said flexible support layer or said flexible antimicrobial layer having an immobilized metal-ion sequestering agent; and
a flexible adhesive layer adjacent said second side of said support layer.

In accordance with another aspect of the present invention there is provided a flexible multi-layer medium comprising:
a flexible support layer having a first side and a second side;
a flexible antimicrobial layer adjacent said first side of said support layer;
a flexible polymeric layer adjacent said flexible support layer or said flexible antimicrobial layer having an immobilized metal-ion sequestering agent; and
a flexible adhesive layer adjacent said second side of said support layer that can be configured to a non flat surface.

These and other aspects, objects, features and advantages of the present invention will be more clearly understood and appreciated from a review of the following detailed description of the preferred embodiments and appended claims, and by reference to the accompanying drawings.

### DESCRIPTION OF THE DRAWINGS

In the detailed description of the preferred embodiments of the invention presented below, reference is made to the accompanying drawings in which:

FIG. 1 illustrates a cross section of an antimicrobial multilayer medium made in accordance with the present invention;

FIG. 2 illustrates a cross section of another embodiment of the multilayer medium made in accordance with the present invention;

FIG. 3 is a schematic of the multilayer medium of FIG. 1 attached to the surface such as a countertop in accordance with the present invention;

FIG. 4 illustrates a cross section of yet another embodiment of the multilayer medium of FIG. 1 made in accordance with the present invention;

FIG. 5 is a schematic illustrating a plurality or sheets of the multilayer medium of FIG. 1 made in accordance with the present invention;

FIG. 6 is a schematic of the multilayer medium of FIG. 1 being attached to a curved surface such as a scale in accordance with the present invention;

FIG. 7 is a schematic of yet another embodiment of the multilayer medium of FIG. 1 being formed to fit the curved surface such as the inside of a cylinder in accordance with the present invention.

FIG. 8 illustrates a cross section of still another embodiment of the multilayer medium made in accordance with the present invention; and

FIG. 9 is an enlarged partial cross sectional view of a portion of the multilayer medium of FIG. 8 illustrating a “free” iron ion sequestering agent and the antimicrobial material.

### DESCRIPTION OF THE PREFERRED EMBODIMENT

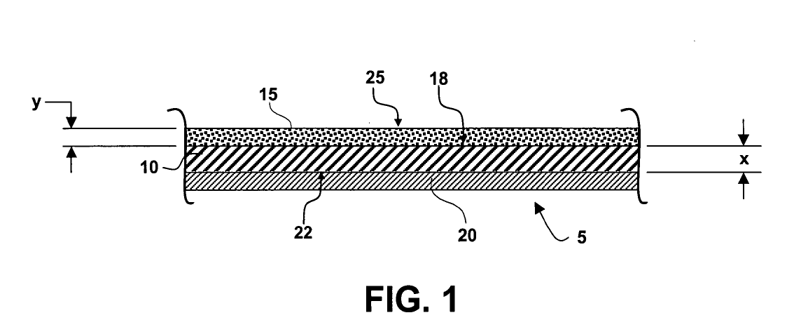

Referring to FIG. 1, there is illustrated a cross-sectional view of an antimicrobial multilayer medium 5, which in the embodiment illustrated, comprises a support layer 10 with an antimicrobial layer 15 coated on the top surface 18 of the support layer 10 with an adhesive layer 20 coated on the bottom surface 22 of the support layer 10. The support layer 10 can be a flexible substrate, which in the embodiment illustrated, has a thickness “x” of between 0.025 millimeters and 5.0 millimeters. In the embodiment illustrated, the thickness x is about 0.125 millimeters. It is, of course, to be understood that thickness of layer 10 may be varied as appropriate. The antimicrobial multilayer medium 5 may be made as a web (not shown) which is described later. Examples of supports useful for practice of the invention are resin-coated paper, paper, polyesters, or micro porous materials such as polyethylene polymer-containing material sold by PPG Industries, Inc., Pittsburgh, Pa. under the trade name of Teslin®, Tyvek® synthetic paper (DuPont Corp.), and OPPalyte® films (Mobil Chemical Co.) and other composite films listed in U.S. Pat. No. 5,244,861. Opaque supports include plain paper, coated paper, synthetic paper, photographic paper support, melt-extrusion-coated paper, and laminated paper, such as biaxially oriented support laminates. Biaxially oriented support laminates are described in U.S. Pat. Nos. 5,853,965; 5,866,282; 5,874,205; 5,888,643; 5,888,681; 5,888,683; and 5,888,714, the disclosures of which are hereby incorporated by reference. These biaxially oriented supports include a paper base and a biaxially oriented polyolefin sheet, typically polypropylene, laminated to one or both sides of the paper base. Transparent supports include glass, cellulose derivatives, e.g., a cellulose ester, cellulose triacetate, cellulose diacetate, cellulose acetate propionate, cellulose acetate butyrate; polyesters, such as poly(ethylene terephthalate), poly(ethylene naphthalate), poly(1,4-cyclohexanedimethylene terephthalate), poly(butylene terephthalate), and copolymers thereof; polyimides; polyamides; polycarbonates; polystyrene; polyolefins, such as polyethylene or polypropylene; polysulfones; polyacrylates; polyether imides; and mixtures thereof. The papers listed above include a broad range of papers from high end papers, such as photographic paper, to low end papers, such as newsprint. Another example of supports useful for practice of the invention are fabrics such as wools, cotton, polyesters, etc. The multilayer medium 5 may be, for example, in the form of a web or a sheet.

The antimicrobial active material of antimicrobial layer 15 may be selected from a wide range of known antibiotics and antimicrobials. An antimicrobial material may comprise an antimicrobial ion, molecule and/or compound, metal ion exchange materials exchanged or loaded with antimicrobial ions, molecules and/or compounds, ion exchange polymers and/or ion exchange latexes, exchanged or loaded with antimicrobial ions, molecules and/or compounds. Suitable materials are discussed in “Active Packaging of Food Applications” A. L. Brody, E. R. Strupinsky and L. R. Kline, Technomic Publishing Company, Inc. Pennsylvania (2001). Examples of antimicrobial agents suitable for practice of the invention include benzoic acid, sorbic acid, nisin, thymol, allicin, peroxides, imazalil, triclosan, benomyl, metal-ion release agents, metal colloids, anhydrides, and organic quaternary ammonium salts. Preferred antimicrobial reagents are metal ion exchange reagents such as silver sodium zirconium phosphate, silver zeolite, or silver ion exchange resin which are commercially available. The antimicrobial layer 15 generally has a thickness “y” of between 0.1 microns and 100 microns, preferably in the range of 1.0 and 25 microns. In the embodiment illustrated the thickness “y” is about 5 microns.

The adhesive used to form the adhesive layer 20 is typical of the adhesive layer found on the back shelving papers such as a reposition adhesive such as the adhesive used in 3M™ Scotch® 859 Removable Mounting Squares and 3M™ Scotch® Repositionable Glue Tape 928-100.

In another embodiment of the antimicrobial multilayer medium 5, the adhesive layer 20 may be a flexible static-cling vinyl such as Trans-Flex-Cast commercially available from Transilwrap Co., Inc., 9201 W. Belmont Ave., Franklin Park, Ill.

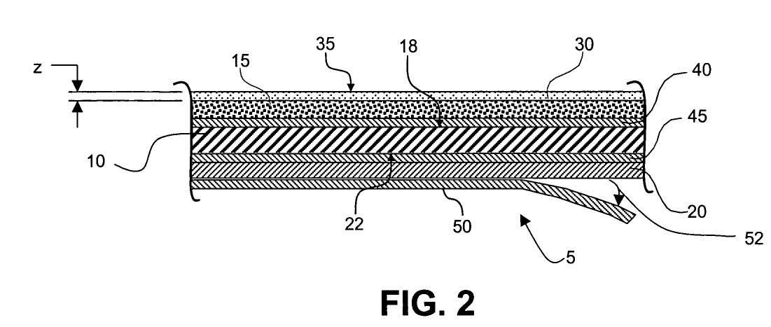

A second embodiment of the antimicrobial multilayer medium 5, made in accordance the present invention, is shown in FIG. 2. In this embodiment, a diffusion layer 30, having a thickness “z” of between 0.2 microns and 25 microns is used to control the amount of antimicrobial material reaching the outer surface 35 of the multilayer medium 5 is placed over the antimicrobial layer 15. Diffusion control layers suitable for the practice of the invention are described in U.S. application Ser. No. 10/737,455 filed Dec. 16, 2003 entitled “Antimicrobial Silver containing article having controlled silver ion activity” by Joseph F. Bringley. The antimicrobial material comprises, for example, a silver ion that travels from antimicrobial layer 15 through the diffusion layer 30 to the outer surface 35 of the multilayer medium 5 where the antimicrobial material stops or retards the growth of microbes. As the antimicrobial is depleted on the outer surface 35, more antimicrobial travels through the diffusion layer 30.

Depending upon the material chosen for the support layer, an additional layer called a subbing layer 40 may be coated on the top surface 18 of the support layer 10. The subbing layer 40 is used to insure proper adhesion of the antimicrobial layer 15 to the support layer 10. Likewise, a subbing layer 45 maybe coated on the bottom surface 22 of the support layer 10. The subbing layer 45 is used to insure proper adhesion of an adhesive layer 20 to the support layer 10. As previously discussed, depending on what material is used for the base 10, the subbing layer 45 may or may not be required. Preparing a support surface (hydrophobic) such as cellulose triacetate to accept an aqueous cast polymer such as polyvinyl alcohol may require chemical and/or an interlayer coating (subbing layer) to improve adhesion. An example of this could be found in photographic patent literature where gelatin based hydrophilic photographic materials are commonly attached to hydrophobic supports such as polyethylene terephthalate. In the embodiment illustrated, an optional peelable protective release layer 50 is provided over adhesive layer 20 for protecting the adhesive layer 20 until it is to be used for securing the multilayer medium 5 to a surface. Preferred protective release materials include polyester, cellulose paper, and biaxially oriented polyolefin. The release layer 50 is peeled off the adhesive layer 20 as indicated by arrow 52 whereby the multilayer medium 5 is secured to the desired surface.

A web (not shown) of the antimicrobial medium 5 can be made by several possible methods. In one embodiment, the antimicrobial web is made by coating the surface 18 of a plastic, paper or fabric support 10 with a polymeric layer containing one or more antimicrobial compounds. The antimicrobial is typically dispersed or dissolved in a medium or solvent. The medium or solvent may contain a binder to allow the antimicrobial to adhere to the support 10 and may contain other addenda such as coating aids, surfactants, plasticizers, etc. to aid the coating process. The coating may be applied by painting, spraying or casting. It is preferred to apply the coating via a solvent assisted process (aqueous or organic) such as blade, rod, knife or curtain coating. The antimicrobial web may also be made by extrusion, or coextrusion of polymeric layers such that at least one layer comprises an antimicrobial compound and the color indicating chemistry described below. The antimicrobial web may also be prepared by blow molding.

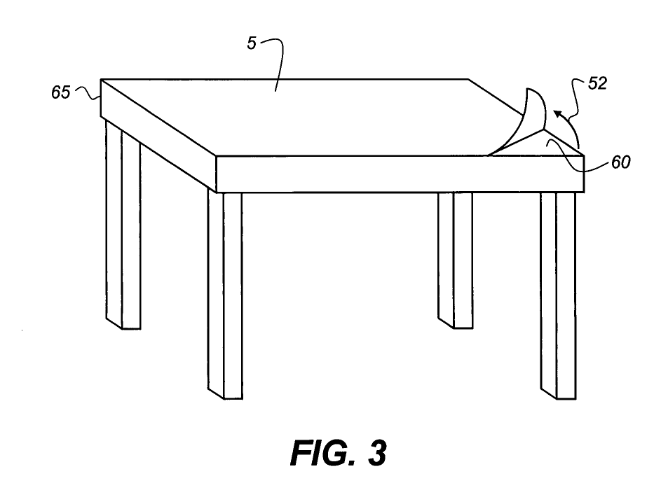

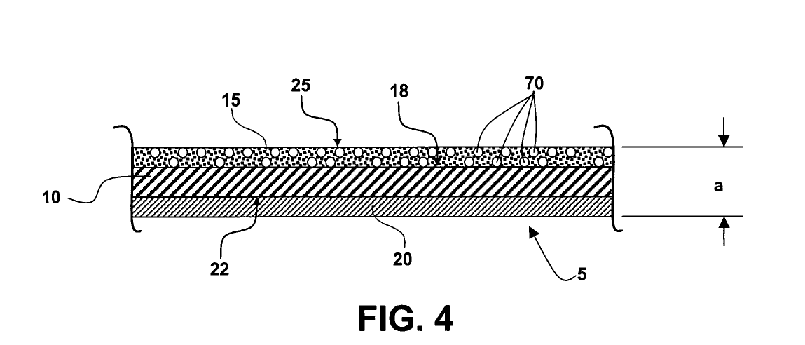

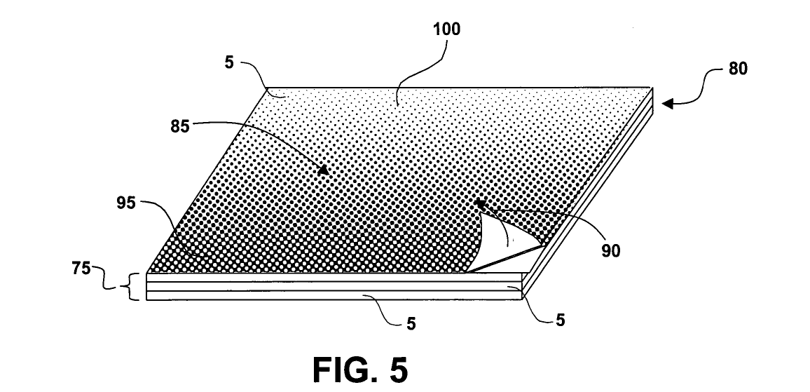

Now referring to FIG. 3, there is illustrated a sheet of multilayer medium 5 of FIG. 1 attached to a top surface 60 of a counter or table 65 in accordance with the present invention. The sheet of multilayer medium 5 is attached via the adhesive layer 20 previously described. In the particular embodiment illustrated, the support layer 10 is, for example, polyethylene, which provides the sheet of multilayer medium 5 with excellent wear characteristics. The sheet of multilayer medium 5 in this embodiment has a thickness “a” of between 0.025 millimeters and 6 millimeters (shown in FIG. 4) is applied to the top surface 60 by first peeling the protective release layer 50 from the adhesive layer 20 as previously described in FIG. 2. The sheet of multilayer medium 5 is then placed onto the surface in a fashion similar to applying adhesive backed shelf paper to a shelf. The multilayer medium 5 remains on the top surface 60 of the counter 65 until the antimicrobial material is substantially depleted or is substantially no longer effective at which point the sheet of multilayer medium 5 is peeled from the top surface 60 of the counter 65 and indicated by the arrow 52 and replaced with a new sheet of multilayer medium 5. The method for determining when the antimicrobial properties of the sheet of multilayer medium 5 have been depleted and are no longer effective and the sheet of multilayer medium 5 should be replaced is described below in FIGS. 4 and 5.

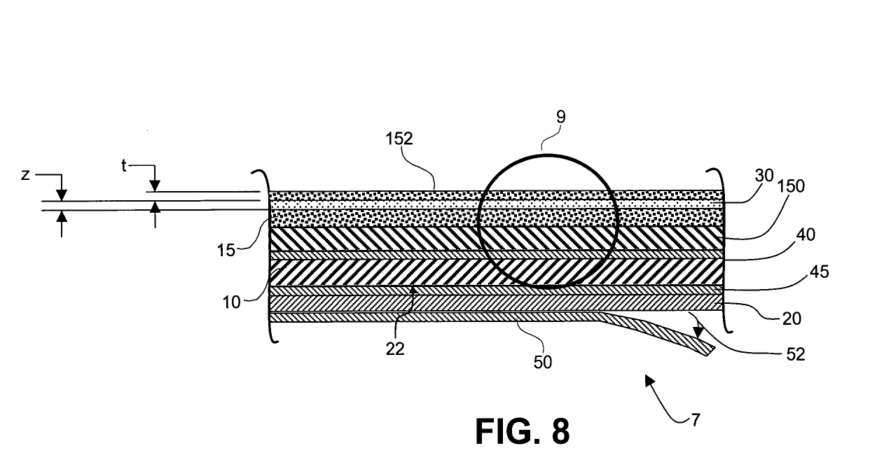

Now referring to FIG. 4, there illustrates a cross section of yet another embodiment the multilayer medium 5 of FIG. 1 made in accordance with the present invention. In this embodiment, as the antimicrobial material and/or metal-ion sequestrant in layer 15 and layer 150 (shown in FIG. 8) respectively is being depleted, the antimicrobial and/or metal-ion sequestrant in layer 15 and layer 150 respectively changes its visual appearance as the effectiveness (shown in FIG. 5) of the antimicrobial material and/or metal-ion sequestrant is reduced. In this manner, the user is prompted that the sheet of multilayer medium 5 may need to be replaced. Depending upon the antimicrobial material being utilized, a visual change, such as a color change upon depletion of the material, may be realized in a variety of ways. The color indicating chemistry 70 of the multilayer medium 5 may be contained within the antimicrobial and/or metal-ion sequestrant in layer 15 and layer 150 respectively per FIG. 1 and FIG. 8, or in the diffusion layer 30 shown in FIG. 2 and FIG. 8, or in both. We discuss below multiple ways to achieve a color indicating change although the invention is not limited only to these methods. For example, but not limited to, the color may change from green to red or from white to black. Preferably, the color changes incrementally upon depletion (loss of effectiveness) of the antimicrobial material. Also the color change is preferably about equal or greater than a 0.2 change in optical density, and more preferably greater than a 0.5 change in optical density. Preferably, the color changes incrementally upon saturation (loss of effectiveness) of the metal ion sequestering agent. Also the color change is preferably about equal or greater than a 0.2 change in optical density, and more preferably greater than a 0.5 change in optical density.

In a preferred embodiment, the multilayer medium 5 contains an antimicrobial material comprising a metal ion exchange material which is exchanged with at least one antimicrobial metal ion selected from silver, copper, gold, nickel or zinc, and is additionally exchanged with at least one colored metal ion, or colored metal ion complex. The colored metal ion or metal ion complex may be antimicrobial or may be inert. The colored metal ion or metal ion complex imparts color to the antimicrobial sheet and upon exposure to a biological medium, diffuses into the medium, and is depleted in the same manner that the antimicrobial metal ion is depleted. As the colored metal ion or colored metal-ion complex is depleted, the web changes color. The amount of exchanged colored metal ion or metal ion complex is determined such the rate of depletion of the colored metal ion is similar to the rate of depletion of the antimicrobial metal ion, and thus, the loss of color from the web indicates a loss of antimicrobial activity. In a further preferred embodiment, the antimicrobial material consists of metal ion exchanged zirconium phosphate, zeolite or other metal ion exchanged resin, which is exchanged with at least one antimicrobial metal ion selected from silver, copper, gold, nickel or zinc, and is additionally exchanged with at least one highly colored metal ion or metal ion complex. Colored metal ions or metal ion complexes suitable for practice of the invention are Cu(II), Co(II), Co(III), Ni(II), Manganese ion, Cr(III), Fe(II), Fe(III), Ni(II) and metal ion complexes such as Co(NH₃)₆³⁺, Cu(NH₃)₄²⁺.

Alternatively, color indication can be provided in the diffusion control layer 30 shown in FIG. 2 by incorporating therein a colored material such as a dye which may diffuse from the layer when the sheet is exposed to a biological environment. In this case it is preferred that the colored material be soluble in water so that its diffusion rate can be used to approximate the depletion rate of the antimicrobial active material. The amount of dye to be incorporated into the diffusion layer 30 should be such as to impart clearly visible color to the sheet. The solubility of the dye, its rate of depletion from the diffusion layer 30, and the rate of depletion of the antimicrobial material from the web may be determined by one skilled in the art.

Another approach to providing color indication for the antimicrobial web is to incorporate a colorless, or colored, precursor material which then reacts with a diffusible species such as antimicrobial ions, to form a colored molecule or material, or a material of a different color than the precursor. In this manner, as more antimicrobial ions diffuse through the web, more dye is produced thus producing a visual color indication. In a preferred embodiment the dye precursor is contained in the diffusion control layer 30 and reacts with diffusing antimicrobial metal ions selected from silver, copper, gold, zinc and nickel to produce a colored material. A working example of the color indicating chemistry 70 is illustrated below in which a metalized dye is formed by reaction of a metal ion with the ligand, 2-methyl-5-hydroxy-8-(2-pyridylazo)-quinoline-3-carboxylic acid. The reaction forms a very highly colored dye having the stoichiometry M(ligand) or M(Ligand)₂. Examples of suitable metal ions are copper, zinc, cobalt and nickel.

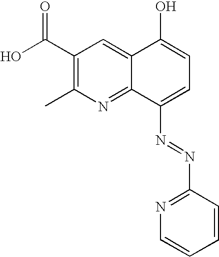

Now referring again to FIG. 5 still another embodiment of the present invention is illustrated. A plurality of antimicrobial sheets 75 is layered together to form a stack 80. As the effectiveness of the antimicrobial is depleted or reduced, the top surface 85, where the antimicrobial is no longer effective, changes color or light and darkness as indicated by the dark area 95. The area where the antimicrobial is still effective is indicated by the light area 100. When the antimicrobial is no longer effective, the top sheet of the multilayer medium 5 can now be removed by simply peeling away the top sheet of the multilayer medium 5 as indicated by the arrow 90 leaving a fresh antimicrobial sheet of the multilayer medium 5 on the surface.

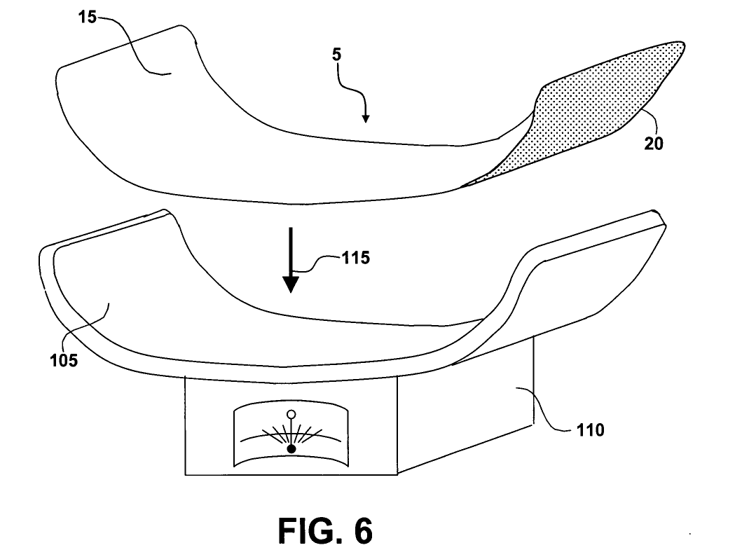

Now referring to FIG. 6, there is illustrated the sheet of the multilayer medium 5 being attached to a curved surface 105, for example, of a scale 110. The flexibility of the sheet of the multilayer medium 5 allows it to conform to the curvature of the scale 110. The adhesive layer 20 attaches the sheet 5 securely to the curved surface 110. The sheet 5 is applied to the curved surface 105 by first peeling the protective release layer 50 from the adhesive layer 20 as previously shown in FIG. 2. The sheet of multilayer medium 5 is then placed onto the surface as indicated by arrow 115 in a fashion similar to applying adhesive backed shelf paper to a shelf.

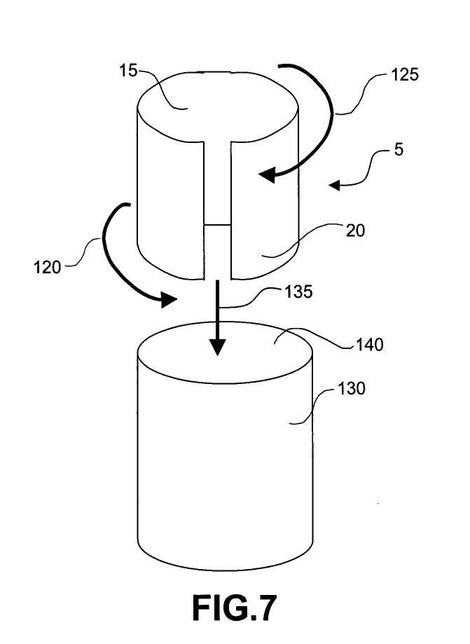

Yet another embodiment of the present invention is illustrated in FIG. 7. The sheet of multilayer medium 5 is formed as indicated by the arrows 120 and 125 to slide into the cylinder 130 as indicated by arrow 135. Once inside the cylinder 130, the sheet 5 flexes outward until it conforms to the inner surface 140 of the cylinder 130.

The mulitilayer medium of the invention comprises an immobilized metal-ion sequestering agent. The term immobilized, as used herein, defines the metal-ion sequestrant as being attached to a rigid or semi-rigid object, and as such, the metal-ion sequestrant is not free to diffuse away from the object or to dissolve into the liquid medium in which the object is immersed. The metal-ion sequestrant may be immobilized by means of a covalent chemical bond, or may be electrostatically immobilized on a support such as by mordant polymers, or may be immobilized via intercalation chemistry. The object may be a support such as glass, paper, plastic, cellulose, textiles, metal or wood. It is preferred that the sequestering agent is immobilized on a particle or a polymer. It is preferred that the sequestering agent has a high stability constant for a target metal-ion. It is further preferred that the metal-ion sequestrant has a high-affinity for biologically significant metal-ions, such as, Zn, Cu, Mn and Fe.

A measure of the “affinity” of metal-ion sequestrants for various metal-ions is given by the stability constant (also often referred to as critical stability constants, complex formation constants, equilibrium constants, or formation constants) of that sequestrant for a given metal-ion. Stability constants are discussed at length in “Critical Stability Constants”, A. E. Martell and R. M. Smith, Vols. 1-4, Plenum, N.Y. (1977), “Inorganic Chemetal-ion sequestranttry in Biology and Medicine”, Chapter 17, ACS Symposium Series, Washington, D.C. (1980), and by R. D. Hancock and A. E. Martell, Chem. Rev. vol. 89, p. 1875-1914 (1989). The ability of a specific molecule or ligand to sequester a metal-ion may depend also upon the pH, the concentrations of interfering ions, and the rate of complex formation (kinetics). Generally, however, the greater the stability constant, the greater the binding affinity for that particular metal-ion. Often the stability constants are expressed as the natural logarithm of the stability constant. Herein the stability constant for the reaction of a metal-ion (M) and a sequestrant or ligand (L) is defined as follows:
M+n L⇄MLₙ

where the stability constant is βₙ=[MLₙ]/[M][L]ⁿ, wherein [MLₙ] is the concentration of “complexed” metal-ion, [M] is the concentration of free (uncomplexed) metal-ion and [L] is the concentration of free ligand. The log of the stability constant is log βₙ, and n is the number of ligands which coordinate with the metal. It follows from the above equation that if βₙ is very large, the concentration of “free” metal-ion will be very low. Ligands with a high stability constant (or affinity) generally have a stability constant greater than 10¹⁰ or a log stability constant greater than 10 for the target metal. Preferably the ligands have a stability constant greater than 10¹⁵ for the target metal-ion. Table 1 lists common ligands (or sequestrants) and the natural logarithm of their stability constants (log βₙ) for selected metal-ions.

TABLE 1
Common ligands (or sequestrants) and the natural logarithm of their
stability constants (log βₙ) for selected metal-ions.

| Ligand | Ca | Mg | Cu(II) | Fe(III) | Al | Ag | Zn |
|---|---|---|---|---|---|---|---|
| alpha-amino | | | | | | | |
| carboxylates | | | | | | | |
| EDTA | 10.6 | 8.8 | 18.7 | 25.1 | | 7.2 | 16.4 |
| DTPA | 10.8 | 9.3 | 21.4 | 28.0 | 18.7 | 8.1 | 15.1 |
| CDTA | 13.2 | | 21.9 | 30.0 | | | |
| NTA | | | | 24.3 | | | |
| DPTA | 6.7 | 5.3 | 17.2 | 20.1 | 18.7 | 5.3 | |
| PDTA | 7.3 | | 18.8 | | | | 15.2 |
| citric Acid | 3.50 | 3.37 | 5.9 | 11.5 | 7.98 | 9.9 | |
| salicylic acid | | | | 35.3 | | | |
| Hydroxamates | | | | | | | |
| Desferrioxamine B | | | | 30.6 | | | |
| acetohydroxamic | | | | 28 | | | |
| acid | | | | | | | |
| Catechols | | | | | | | |
| 1,8-dihydroxy | | | | 37 | | | |
| naphthalene | | | | | | | |
| 3,6 sulfonic acid | | | | | | | |
| MECAMS | | | | 44 | | | |
| 4-LICAMS | | | | 27.4 | | | |
| 3,4-LICAMS | 16.2 | | | 43 | | | |
| 8-hydroxyquinoline | | | | 36.9 | | | |
| disulfocatechol | 5.8 | 6.9 | 14.3 | 20.4 | 16.6 | | |
| EDTA is ethylenediamine tetraacetic acid and salts thereof, | | | | | | | |
| DTPA is diethylenetriaminepentaacetic acid and salts thereof, | | | | | | | |
| DPTA is Hydroxylpropylenediaminetetraacetic acid and salts thereof, | | | | | | | |
| NTA is nitrilotriacetic acid and salts thereof, | | | | | | | |
| CDTA is 1,2-cyclohexanediamine tetraacetic acid and salts thereof, | | | | | | | |
| PDTA is propylenediammine tetraacetic acid and salts thereof. | | | | | | | |
| Desferroxamine B is a commercially available iron chelating drug, desferal ®. | | | | | | | |
| MECAMS, 4-LICAMS and 3,4-LICAMS are described by Raymond et al. in “Inorganic Chemetal-ion sequestranttry in Biology and Medicine”, Chapter 18, ACS Symposium Series, Washington, D.C. (1980). Log stability constants are from “Critical Stability Constants”, A. E. Martell and R. M. Smith, Vols. 1-4, | | | | | | | |
| # Plenum Press, NY (1977); “Inorganic Chemetal-ion sequestranttry in Biology and Medicine”, Chapter 17, ACS Symposium Series, Washington, D.C. (1980); R. D. Hancock and A. E. Martell, Chem. Rev. vol. 89, p. 1875-1914 (1989) and “Stability Constants of Metal-ion Complexes”, The Chemical Society, London, 1964. | | | | | | | |

In some instances, it may be necessary to remove specific metal-ion(s) from a target environment. The target environment is a liquid environment, e.g., food extrudates or residues containing nutrients left behind after the preparation of foods and beverages. In such cases it may be desirable to immobilize a metal-ion sequestrant with a very high specificity or selectivity for a given metal-ion. Immobilized metal-ion sequestrants of this nature may be used to control the concentration of the target metal-ion. One skilled in the art may prepare such immobilized metal-ion sequestrants by selecting a metal-ion sequestrant having a high specificity for the target metal-ion. The specificity of a metal-ion sequestrant for a target metal-ion is given by the difference between the log of the stability constant for the target metal-ion, and the log of the stability constant for the interfering metal-ions. For example, if a treatment required the removal of Fe(III), but it was necessary to leave the Ca-concentration unaltered, then from Table 1, DTPA would be a suitable choice since the difference between the log stability constants 28-10.8=17.2, is very large. 3,4-LICAMS would be a still more suitable choice since the difference between the log stability constants 43-16.2=26.8, is the largest in Table 1.

It is preferred that the immobilized metal-ion sequestrants have a high stability constant for the target metal-ion(s). The stability constant for the immobilized metal-ion sequestrant will largely be determined by the stability constant for the attached metal-ion sequestrant. However, the stability constant for the immobilized metal-ion sequestrants may vary somewhat from that of the attached metal-ion sequestrant. Generally, it is anticipated that metal-ion sequestrants with high stability constants will give immobilized metal-ion sequestrants with high stability constants. For a particular application, it may be desirable to have an immobilized metal-ion sequestrant with a high selectivity for a particular metal-ion. In most cases, the immobilized metal-ion sequestrant will have a high selectivity for a particular metal-ion if the stability constant for that metal-ion is about 10⁶ greater than for other ions present in the system.

It is preferred that the immobilized metal-ion sequestrant of the invention has a high-affinity for iron, and in particular iron(III). It is preferred that the stability constant of the sequestrant for iron(III) be greater than 10¹⁰. It is still further preferred that the metal-ion sequestrant has a stability constant for iron greater than 10²⁰.

Metal-ion sequestrants may be chosen from various organic molecules. Such molecules having the ability to form complexes with metal-ions are often referred to as “chelators”, “complexing agents”, and “ligands”. Certain types of organic functional groups are known to be strong “chelators” or sequestrants of metal-ions. It is preferred that the sequestrants of the invention contain alpha-amino carboxylates, hydroxamates, or catechol, functional groups. Hydroxamates, or catechol, functional groups are preferred. Alpha-amino carboxylates have the general formula:
R—[N(CH₂CO₂M)—(CH₂)ₙ—N(CH₂CO₂M)₂]ₓ
where R is an organic group such as an alkyl or aryl group; M is H, or an alkali or alkaline earth metal such as Na, K, Ca or Mg, or Zn; n is an integer from 1 to 6; and x is an integer from 1 to 3. Examples of metal-ion sequestrants containing alpha-amino carboxylate functional groups include ethylenediaminetetraacetic acid (EDTA), ethylenediaminetetraacetic acid disodium salt, diethylenetriaminepentaacetic acid (DTPA), Hydroxylpropylenediaminetetraacetic acid (DPTA), nitrilotriacetic acid, triethylenetetraaminehexaacetic acid, N,N-bis(o-hydroxybenzyl) ethylenediamine-N,N′ diacteic acid, and ethylenebis-N,N′-(2-o-hydroxyphenyl)glycine.

Hydroxamates (or often called hydroxamic acids) have the general formula: 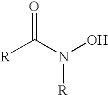
where R is an organic group such as an alkyl or aryl group. Examples of metal-ion sequestrants containing hydroxamate functional groups include acetohydroxamic acid, and desferroxamine B, the iron chelating drug desferal.

Catechols have the general formula: 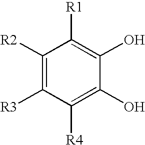
Where R1, R2, R3 and R4 may be H, an organic group such as an alkyl or aryl group, or a carboxylate or sulfonate group. Examples of metal-ion sequestrants containing catechol functional groups include catechol, disulfocatechol, dimethyl-2,3-dihydroxybenzamide, mesitylene catecholamide (MECAM) and derivatives thereof, 1,8-dihydroxynaphthalene-3,6-sulfonic acid, and 2,3-dihydroxynaphthalene-6-sulfonic acid.

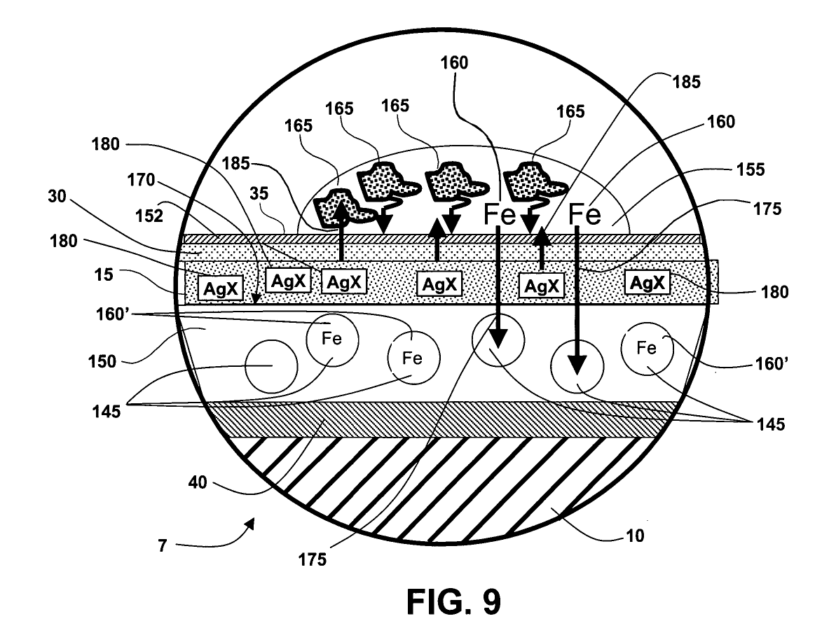

The combination antimicrobial metal-ion sequestering multilayer medium 7 similar to the multilayer medium 5, like numerals indicating like elements and function as previously discussed. The multilayer medium 7 which includes a support layer 10 with an antimicrobial layer 15 as previously described is preferably coated on the top surface 170 of a polymeric layer 150 with an adhesive layer 20 coated on the bottom surface 22 of the support layer 10. The polymeric layer 150 contains an immobilized metal-ion sequestering agent or sequestrant such as EDTA. In the embodiment illustrated, the immobilized metal-ion sequestering agent or sequestrant is provided in a separate layer. It is of course understood that the metal-ion sequestrant 145 may be placed in the diffusion layer 30 and/or the antimicrobial layer 15. If the metal-ion sequestrant 145 is placed in the diffusion layer 30, an additional barrier layer 152 maybe added. The metal-ion sequestrant 145 removes designated essential bio-metal ions from any nutrient residue 155 deposited on the surface 35 during the preparation of food as shown in FIG. 9. The removal of the essential bio-metal ions such as a “free” iron ion 160 will further inhibit the growth of microbes in said nutrient residue 155. The primary purpose of the diffusion layer 30 and the barrier layer 152 is to provide a barrier through which micro-organisms 165 present in the nutrient residue 155 cannot pass. It is important to limit, or eliminate, in certain applications, the direct contact of micro-organisms 165 with the metal-ion sequestrant 145, since many micro-organisms 165, under conditions of iron deficiency, may bio-synthesize molecules which are strong chelators for iron, and other metals. These bio-synthetic molecules are called “siderophores” and their primary purpose is to procure iron for the micro-organisms 165. Thus, if the micro-organisms 165 are allowed to directly contact the metal-ion sequestrant 145, they may find a rich source of iron there, and begin to colonize directly at these surfaces. The siderophores produced by the micro-organism may compete with the metal-ion sequestrant for the iron (or other bio-essential metal) at their surfaces. However the energy required for the organisms to adapt their metabolism to synthesize these siderophores will impact significantly their growth rate. Thus, one object of the invention is to lower growth rate of organisms in the nutrient residue 155. Since the diffusion 30 and/or the barrier layer 152 of the invention does not contain the metal-ion sequestrant 145, and because the micro-organisms 165 are large, the micro-organisms may not pass or diffuse through the diffusion layer 30 and/or the barrier layer 152. The diffusion layer 30 and/or the barrier layer 152 thus prevent contact of the micro-organisms 165 with the polymeric layer 150 containing the metal-ion sequestrant 145 of the invention. It is preferred that both the diffusion layer 30 and/or the barrier layer 152 are permeable to water. It is preferred that the barrier layer 152 has a thickness “t” in the range of 0.1 microns to 10.0 microns and is preferred that both diffusion layer 30 and the barrier layer 152 (if a barrier layer is present) have a combined thickness “t+z” in the range of 0.1 microns to 10.0 microns. It is preferred that microbes are unable to penetrate, to diffuse or pass through the diffusion layer 30 and/or the barrier layer 152.

Referring now to FIG. 9, there is illustrated an enlarged partial cross-sectional view of a portion of the combination antimicrobial multilayer medium 7 of FIG. 8. In the embodiment shown the polymeric layer 150 contains a metal-ion sequestrant 145. The diffusion layer 30 preferably does not contain the metal-ion sequestrant 145 so no barrier layer is present.

Still referring again to FIG. 9, the nutrient residue 155 is shown in direct contact with multilayer medium 7. In order for the metal-ion sequestrant 145 to work properly, the polymeric layer 150 containing the metal-ion sequestrant 145 must be permeable to aqueous media. Preferred polymers for layers 15, 30, 150 and 152 (shown in FIG. 8) of the invention are polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene, polypropylene or polyacrylonitrile. A water permeable polymer permits water to move freely through the polymer 15, 30, 150 and 152 allowing the “free” iron ion 160 to reach and be captured by the sequestrant 145 as indicated by arrows 175. The micro-organism 165 is too large to pass through the diffusion layer 30 or the antimicrobial layer 15 or the polymeric layer 150 so it cannot reach the sequestered iron ion 160′ now held by the metal-ion sequestrant 145. By using the metal-ion sequestrant 145 to significantly reduce the amount of “free” iron ions 165 in the nutrient residue 155, the growth of the micro-organism 165 is eliminated or severely reduced. Sequestrant 145 with a sequestered metal ion is indicated by numeral 160′. At the same time as the “free” iron ions 165 are being removed from the nutrient residue 155 the silver antimicrobial ion 180 travels from antimicrobial layer 15 through the diffusion layer 30 to the outer surface 35 of the multilayer medium 7 as indicated by arrows 185 where the antimicrobial material stops or retards the growth of micro-organism 165. As the antimicrobial is depleted on the outer surface 35, more antimicrobial travels through the diffusion layer 30.

It is to be understood that various other changes and modifications may be made without departing from the scope of the present invention, the present invention being defined by the following claims.

Parts List:

5 antimicrobial multilayer medium
7 combination antimicrobial metal-ion sequestering multilayer medium
10 support layer
15 antimicrobial layer
18 top surface
20 adhesive layer
22 bottom surface
25 outer surface
30 diffusion layer
35 outer surface
40 subbing layer
45 subbing layer
50 release layer
52 arrow
55 sheet
60 top surface
65 counter top/table
70 color indicating chemistry
75 plurality of antimicrobial sheets
80 stack
85 top surface
90 arrow
95 dark area
100 light area
105 curved surface
110 scale
115 arrow
120 arrow
125 arrow
130 cylinder
135 arrow
140 inner surface
145 metal-ion sequestrant
150 separate metal-ion sequestrant layer
152 barrier layer
155 nutrient residue
160 “free” iron ion
165 micro-organism
170 top surface
175 arrow
180 silver antimicrobial ion
185 arrow

1. A flexible multi-layer medium comprising:
a flexible support layer having a first side and a second side;
a flexible antimicrobial layer adjacent said first side of said support layer;
a flexible a polymeric layer adjacent said flexible support layer or said flexible antimicrobial layer having an immobilized metal-ion sequestering agent; and
a flexible adhesive layer adjacent said second side of said support layer.

2. A medium according to claim 1 wherein said antimicrobial layer changes color as the effectiveness of said antimicrobial is reduced.

3. A medium according to claim 1 wherein said antimicrobial layer provides a controlled release of an antimicrobial material.

4. A medium according to claim 3 wherein said controlled release is accomplished by use of a diffusion layer placed over said antimicrobial layer.

5. A medium according to claim 3 wherein said antimicrobial material comprises an antimicrobial metal ion exchange material which is exchanged with at least one colored metal ion or colored metal ion complex.

6. A medium according to claim 5 wherein said antimicrobial metal ion is selected from one of the following:
silver
gold
copper
zinc
nickel

7. A medium according to claim 1 wherein a colored material is provided in said medium that has a diffusion rate substantially the same as the depletion rate of the active ingredient in said antimicrobial layer so that a visual indication will be provided as to the effectiveness of said active ingredient.

8. A medium according to claim 1 wherein the color change is about equal or greater than a 0.2 change in optical density.

9. A medium according to claim 8 wherein the color change is greater than a 0.5 change in optical density.

10. A medium according to claim 1 wherein the antimicrobial layer is made from one or more of the following antimicrobial compounds:
silver sodium zirconium phosphate, silver zeolite, silver ion exchange resins, benzoic acid, sorbic acid, nisin, thymol, allicin, peroxides, imazalil, triclosan, benomyl, metal-ion release agents, metal colloids, anhydrides, and organic quaternary ammonium salts.

11. A medium according to claim 1 wherein the support layer is made from one or more of the following:
resin-coated paper
paper, polyesters
micro porous materials
polyethylene
plain paper
coated paper
synthetic paper
photographic paper support
melt-extrusion-coated paper
laminated paper
biaxially oriented polyolefin
polypropylene
glass
cellulose derivatives
polyesters.

12. A medium according to claim 1 wherein the adhesive layer is made from one or more of the following:
reposition adhesive
flexible static-cling vinyl.

13. A medium according to claim 1 wherein the diffusion layer comprises a dye which diffuses from the diffusion layer when the sheet is exposed to a biological environment.

14. A medium according to claim 1 wherein the antimicrobial layer has a thickness in the range of 0.01 μm to 100 μm.

15. A medium according to claim 1 wherein the thickness of said antimicrobial layer is about 5 μm.

16. A medium according to claim 1 wherein the support layer has a thickness in the range of 0.025 mm to 5 mm.

17. A medium according to claim 1 wherein the thickness of said support layer is about 0.125 mm.

18. A medium according to claim 4 wherein the diffusion layer has a thickness in the range of 0.2 μm to 25 μm.

19. A medium according to claim 4 wherein the thickness of said diffusion layer is about 5 μm.

20. A medium according to claim 1 further comprising a subbing layer provided between support layer and said antimicrobial layer for providing proper adhesion of the antimicrobial layer to said support layer.

21. A medium according to claim 1 wherein a removable protective layer is provided over said adhesive layer for protecting said adhesive layer until it can be secured to a receiving surface.

22. A medium according to claim 1 wherein said immobilized metal-ion sequestering agent has a high-affinity for iron (III).

23. A medium according to claim 1 wherein said immobilized metal-ion sequestering agent has a stability constant greater than 10¹⁰.

24. A medium according to claim 1 wherein said immobilized metal-ion sequestering agent has a stability constant greater than 10²⁰.

25. A medium according to claim 1 wherein said immobilized metal-ion sequestering agent contains alpha-amino carboxylates, hydroxamates, or catechol, functional groups.

26. A medium according to claim 1 wherein said flexible polymeric layer changes color changes incrementally upon saturation of the metal ion sequestering agent

27. A medium according to claim 1 wherein said flexible polymeric layer is made from any of the following:
polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene, polypropylene or polyacrylonitrile.

28. A multi-layer medium comprising:
a support layer having a first side and a second side;
an antimicrobial layer adjacent said first side of said support layer, said antimicrobial layer having an indicating means for providing a visual indication of the effectiveness of the antimicrobial layer;
a flexible polymeric layer adjacent said flexible support layer or said flexible antimicrobial layer having an immobilized metal-ion sequestering agent; and
an adhesive layer adjacent said second side of said support layer.

29. A multi-layer medium according to claim 28 wherein said visual indication means comprises a change in color when the effectiveness of said antimicrobial is reduced.

30. A medium according to claim 28 wherein said antimicrobial layer provides a controlled release of an antimicrobial material.

31. A medium according to claim 30 wherein said controlled release is accomplished by use of a diffusion layer placed over said antimicrobial layer.

32. A medium according to claim 30 wherein said antimicrobial material comprises an antimicrobial metal ion which is exchanged with at least one colored metal ion or colored metal ion complex.

33. A medium according to claim 32 wherein said antimicrobial metal ion is selected from one of the following:
silver
gold
copper
zinc
nickel

34. A medium according to claim 28 wherein a colored material is provided in said medium that has a diffusion rate substantially the same as the depletion rate of the active ingredient in said antimicrobial layer so that a visual indication will be provided as to the effectiveness of said active ingredient.

35. A medium according to claim 29 wherein the color change is about equal or greater than a 0.2 change in optical density.

36. A medium according to claim 35 wherein the color change is greater than a 0.5 change in optical density.

37. A medium according to claim 28 wherein the antimicrobial layer is made from one or more of the following antimicrobial compounds:
silver sodium zirconium phosphate, silver zeolite, silver ion exchange resins benzoic acid, sorbic acid, nisin, thymol, allicin, peroxides, imazalil, triclosan, benomyl, metal-ion release agents, metal colloids, anhydrides, and organic quaternary ammonium salts.

38. A medium according to claim 28 wherein the support layer is made from one or more of the following:
resin-coated paper
paper, polyesters
micro porous materials
polyethylene
plain paper
coated paper
synthetic paper
photographic paper support
melt-extrusion-coated paper
laminated paper
biaxially oriented polyolefin
polypropylene
glass
cellulose derivatives
polyesters.

39. A medium according to claim 28 wherein the adhesive layer is made from one or more of the following:
reposition adhesive
flexible static-cling vinyl.

40. A medium according to claim 31 wherein the diffusion layer comprises a dye which diffuses from the diffusion layer when the sheet is exposed to a biological environment.

41. A medium according to claim 28 wherein the antimicrobial layer has a thickness in the range of 0.01 μm to 100 μm.

42. A medium according to claim 28 wherein the thickness of said antimicrobial layer is about 5 μm.

43. A medium according to claim 28 wherein the support layer has a thickness in the range of 0.025 mm to 5 mm.

44. A medium according to claim 28 wherein the thickness of said support layer is about 0.125 mm.

45. A medium according to claim 31 wherein the diffusion layer has a thickness in the range of 0.2 μm to 25 μm.

46. A medium according to claim 31 wherein the thickness of said diffusion layer is about 5 μm.

47. A medium according to claim 28 further comprising a subbing layer provided between support layer and said antimicrobial layer for providing proper adhesion of the antimicrobial layer to said support layer.

48. A medium according to claim 28 wherein a removable protective layer is provided over said adhesive layer for protecting said adhesive layer until it can be secured to a receiving surface.

49. A medium according to claim 27 wherein said immobilized metal-ion sequestering agent has a high-affinity for iron (III).

50. A medium according to claim 28 wherein said immobilized metal-ion sequestering agent has a stability constant greater than 10¹⁰.

51. A medium according to claim 28 wherein said immobilized metal-ion sequestering agent has a stability constant greater than 10²⁰.

52. A medium according to claim 28 wherein said immobilized metal-ion sequestering agent contains alpha-amino carboxylates, hydroxamates, or catechol, functional groups.

53. A medium according to claim 28 wherein said flexible polymeric layer is made from any of the following:
polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene, polypropylene or polyacrylonitrile.

54. A medium according to claim 28 wherein said flexible a polymeric layer changes color changes incrementally upon saturation of the metal ion sequestering agent

55. A multi-layer medium comprising:
a support layer having a first side and a second side;
an antimicrobial layer adjacent said first side of said support layer having controlled release of the active antimicrobial ingredient in said antimicrobial layer;
a flexible polymeric layer adjacent said flexible support layer or said flexible antimicrobial layer having an immobilized metal-ion sequestering agent; and
an adhesive layer adjacent said second side of said support layer.

56. A medium according to claim 55 wherein said antimicrobial layer changes color as the effectiveness of said antimicrobial is reduced.

57. A medium according to claim 55 wherein said controlled release is accomplished by use of a diffusion layer placed over said antimicrobial layer.

58. A medium according to claim 55 wherein said antimicrobial material comprises an antimicrobial metal ion which is exchanged with at least one colored metal ion or colored metal ion complex.

59. A medium according to claim 55 wherein said antimicrobial metal ion is selected from one of the following:
silver
gold
copper
zinc
nickel

60. A medium according to claim 55 wherein a colored material is provided in said medium that has a diffusion rate substantially the same as the depletion rate of the active ingredient in said antimicrobial layer so that a visual indication will be provided as to the effectiveness of said active ingredient.

61. A medium according to claim 55 wherein the color change is about equal or greater than a 0.2 change in optical density.

62. A medium according to claim 61 wherein the color change is greater than a 0.5 change in optical density.

63. A medium according to claim 55 wherein the antimicrobial layer is made from one or more of the following antimicrobial metal ion compounds:
silver sodium zirconium phosphate, silver zeolite, silver ion exchange resins, benzoic acid, sorbic acid, nisin, thymol, allicin, peroxides, imazalil, triclosan, benomyl, metal-ion release agents, metal colloids, anhydrides, and organic quaternary ammonium salts.

64. A medium according to claim 55 wherein the support layer is made from one or more of the following:
resin-coated paper
paper, polyesters
micro porous materials
polyethylene
plain paper
coated paper
synthetic paper
photographic paper support
melt-extrusion-coated paper
laminated paper
biaxially oriented polyolefin
polypropylene
glass
cellulose derivatives
polyesters.

65. A medium according to claim 55 wherein the adhesive layer is made from one or more of the following:
reposition adhesive
flexible static-cling vinyl.

66. A medium according to claim 57 wherein the diffusion layer comprises a dye which diffuses from the diffusion layer when the sheet is exposed to a biological environment.

67. A medium according to claim 55 wherein the antimicrobial layer has a thickness in the range of 0.1 μm to 25 μm.

68. A medium according to claim 55 wherein the thickness of said antimicrobial layer is about 5 μm.

69. A medium according to claim 55 wherein the support layer has a thickness in the range of 0.025 mm to 5 mm.

70. A medium according to claim 55 wherein the thickness of said support layer is about 0.125 mm.

71. A medium according to claim 57 wherein the diffusion layer has a thickness in the range of 0.2 μm to 25 μm.

72. A medium according to claim 57 wherein the thickness of said diffusion layer is about 5 μm.

73. A medium according to claim 55 further comprising a subbing layer provided between support layer and said antimicrobial layer for providing proper adhesion of the antimicrobial layer to said support layer.

74. A medium according to claim 55 wherein a removable protective layer is provided over said adhesive layer for protecting said adhesive layer until it can be secured to a receiving surface.

75. A medium according to claim 55 wherein said immobilized metal-ion sequestering agent has a high-affinity for iron (III).

76. A medium according to claim 55 wherein said immobilized metal-ion sequestering agent has a stability constant greater than 10¹⁰.

77. A medium according to claim 55 wherein said immobilized metal-ion sequestering agent has a stability constant greater than 10²⁰.

78. A medium according to claim 55 wherein said immobilized metal-ion sequestering agent contains alpha-amino carboxylates, hydroxamates, or catechol, functional groups.

79. A medium according to claim 55 wherein said flexible polymeric layer is made from any of the following:
polyvinyl alcohol, cellophane, water-based polyurethanes, polyester, nylon, high nitrile resins, polyethylene-polyvinyl alcohol copolymer, polystyrene, ethyl cellulose, cellulose acetate, cellulose nitrate, aqueous latexes, polyacrylic acid, polystyrene sulfonate, polyamide, polymethacrylate, polyethylene terephthalate, polystyrene, polyethylene, polypropylene or polyacrylonitrile.

80. A plurality of multi-layer sheets layered together to form a stack of flexible multi-layer medium comprising:
a flexible support layer having a first side and a second side;
a flexible antimicrobial layer adjacent said first side of said support layer;
a flexible a polymeric layer adjacent said flexible support layer or said flexible antimicrobial layer having an immobilized metal-ion sequestering agent; and
a flexible adhesive layer adjacent said second side of said support layer.

81. A flexible multi-layer medium comprising:
a flexible support layer having a first side and a second side;
a flexible antimicrobial layer adjacent said first side of said support layer;
a flexible polymeric layer adjacent said flexible support layer or said flexible antimicrobial layer having an immobilized metal-ion sequestering agent; and
a flexible adhesive layer adjacent said second side of said support layer that can be configured to a non flat surface.

82. A method of attaching the flexible multi-layer medium of claim 80 is attached to a surface via the adhesive layer.

83. A method of claim 81 wherein the antimicrobial material is released in a controlled fashion by use of a diffusion layer placed over said antimicrobial layer.

84. A method of claim 81 wherein the antimicrobial material is substantially depleted or is substantially no longer effective and is peeled from the surface and replaced with a new sheet of multilayer medium.

85. The method of claim 81 wherein the antimicrobial material for determining when the antimicrobial properties of the sheet of multilayer medium changes color as the effectiveness of said antimicrobial is reduced.
